(19) United States
(12) Patent Application Publication
(10) Pub. No.: US 2012/0005685 A1
(43) Pub. Date: Jan. 5, 2012

(54) Information Processing Grid and Method for High Performance and Efficient Resource Utilization

(76) Inventors: Steve S. Chen, San Jose, CA (US); Kitrick Sheets, Lafayette, IN (US); Peter Marosan, Budapest (HU)

(21) Appl. No.: 13/170,894

(22) Filed: Jun. 28, 2011

Related U.S. Application Data
(60) Provisional application No. 61/361,415, filed on Jul. 4, 2010.

(51) Int. Cl. G06F 9/46

(52) U.S. Cl. 718/104

(57) ABSTRACT

System and method are proposed for intelligent assignment of submitted information processing jobs to computing resources in an information processing grid based upon real-time measurements of job behavior and predictive analysis of job throughput and computing resource consumption of the correspondingly generated workloads. The job throughput and computing resource utilization are measured and analyzed in multiple parametric dimensions. The analyzed workload may work with a job scheduling system to provide optimized job dispatchment to computing resources across the grid. Application of a parametric weighting system to the parametric dimensions makes the optimization system dynamic and flexible. Through adjustment of these parametric weights, the focus of the optimization can be adjusted dynamically to support the immediate operational goals of the system as a whole.

### CROSS REFERENCE TO RELATED APPLICATIONS

This application is based upon and claims the priority of a previously filed provisional patent application entitled “Information Processing Grid and Method for Dynamic and Intelligent Workload Deployment” by Steve Chen et al with application No. 61/361,415, filing date Jul. 4, 2010 and attorney docket number IFSG002 whose content is herein incorporated by reference for all purposes.

### FIELD OF THE DISCLOSURE

The present invention relates to network computing, including grid and cloud based computing. More specifically, the present invention is directed to the scheduling and distribution of information processing jobs across a distributed network of cooperating computing resources.

### BACKGROUND OF THE DISCLOSURE

Many public and private organizations throughout the world require access to large amounts of computing resources on an ongoing basis to perform complex computation, which is critical to their research or business mission. Traditionally, computational requirements of an organization have led to the acquisition of larger computer systems over time to support their mission. The cost and complexity of acquiring and maintaining these large computer systems have led organizations to search for effective ways to meet their computing resource requirements. As a general trend due to the advent of Internet, cloud computing is becoming an economical approach for meeting these computing needs.

Cloud computing involves the aggregation of a number of geographically dispersed computer systems or network of systems into a cooperative set that can be applied to performing a set of computational tasks, also called information processing jobs (IPJ). These computing clouds can be shared among organizations (public clouds), between departments within a single organization (private cloud), or any combination thereof. One key advantage is that cloud computing allows the sharing of computational resources over a diverse range of information processing jobs.

Within a cloud, each computational entity, also called an information processing node (IPN), is a computer system comprised of a variety of information processing resources (IPRs). The IPR may include one or more central processing units (CPUs), associated random access_memory (RAM), and typically a network interface card (NIC) capable of communication with other IPNs. Additionally, the IPN may frequently include a persistent data storage device such as a hard disk drive (HDD).

IPJs are submitted to the cloud for execution through the use of a cloud management software, which controls the assignment of these IPJs to available IPNs within the cloud. This job assignment is typically accomplished through the cooperation of cloud managers responsible for dispatching a work load generated by an IPJ to a set of available IPNs within the cloud. Each local cloud manager may have local knowledge of the availability of IPNs within his local computer network. The job assignment may be performed based upon an estimate of the amount of IPRs required to complete the job. This estimate may be supplied by the submitter (user) of the job based on his/her understanding of the computing requirements of the job. An ongoing demand upon cloud computing is for it to automatically provide ever increasing performance with efficient IPR utilization.

### SUMMARY OF THE INVENTION

An inter grid (ITGD) is invented for simultaneously executing a number of information processing jobs IPJᵢ (i=1, 2, . . . , O and O>=1) with efficient utilization of information processing resources (IPR). The execution of each IPJᵢ entails an associated time profile of job throughput and information processing resource utilization JTRUᵢ(t). The invented ITGD includes a number of information processing grids (IPG) IPGⱼ (j=1, 2, . . . , P and P>=1) coupled to one another through a computer network. Each IPGⱼ has:
A grid of coupled information processing nodes IPNⱼₖ (k=1, 2, . . . , Q and Q>=1). Each IPNⱼₖ has its own IPRⱼₖ characterized by an inherent information processing resource capacity (IPRCⱼₖ) of which a resource portion IPRPⱼₖᵢ can be assigned for processing an information processing job IPJᵢ.
A dynamic capacity collection agent (DCCAⱼ) deployed among the IPNⱼₖ (k=1, 2, . . . , Q) for measuring and collecting each JTRUᵢ(t).
A grid job manager (GJMⱼ) deployed by the DCCAⱼ among the IPNⱼₖ (k=1, 2, . . . , Q) and coupled to the DCCAⱼ. The GJMⱼ processes the JTRUᵢ(t) together with the IPRCⱼₖ and dispatches the IPJᵢ (i=1, 2, . . . , O) among the IPNⱼₖ (k=1, 2, . . . , Q) in a shared way so as to achieve an optimized set of JTRUᵢ(t) of maximized overall job throughput and minimized overall degree of information processing resource utilization for the ITGD.

In a more specific embodiment each DCCAⱼ functions autonomously independent of the dispatchment of the IPJᵢ among the information processing nodes.

As a more specific embodiment, the IPRⱼₖ of each IPNⱼₖ includes a set of functionally coupled information processing hardware (IFP-HW) and information processing software (IFP-SW) exhibiting real-time behavioral data correlated to the JTRUᵢ(t). The DCCAⱼ has:
Numerous dynamic probes embedded in the IFP-HW and IFP-SW of each IPNⱼₖ for continually measuring their real-time behavioral data.
Numerous intelligent collectors coupled to the dynamic probes for collecting then intelligently interpreting the so collected real-time behavioral data into an interim job throughput and information processing resource utilization data for each IPJᵢ and each IPRⱼₖ throughout the IPG.
In a preferred embodiment for intelligently interpreting the real-time behavioral data, the intelligent collectors have and employ a set of fuzzy logic rules mapping the real-time behavioral data into the interim job throughput and information processing resource utilization data. Numerous intelligent aggregators coupled to the numerous intelligent collectors for intelligently aggregating the interim job throughput and information processing resource utilization data into the set of JTRUᵢ(t) (i=1, 2, . . . , O). In a preferred embodiment, the intelligent aggregators further normalizes the set of JTRUᵢ(t) so that the job throughput is expressed in the form of %-completion per unit time and the information processing resource utilization is expressed in the form of %-resource utilization. In another preferred embodiment, the intelligent aggregators have and employ a set of weighting coefficients, each reflecting the relative importance of its corresponding IFP-HW or IFP-SW, multiplied to their corresponding interim information processing resource utilization data during the aggregation process.

As a more specific embodiment, the GJMⱼ has:
a) An information processing job-resource (IPJ-IPR) optimizing scheme that, using the normalized set of JTRUᵢ(t), assigns and adjusts all resource portions IPRPⱼₖᵢ for all information processing jobs IPJᵢ for an anticipated optimized set of JTRUᵢ(t). In a preferred embodiment for adjusting all resource portions IPRPⱼₖᵢ for all information processing jobs IPJᵢ, the IPJ-IPR optimizing scheme has and employs a neural network based upon the normalized set of JTRUᵢ(t).
b) A JTRU-iterating scheme that, upon detecting a significant change of the normalized set of JTRUᵢ(t), returns the grid job management control to step a).

As another more specific embodiment, each IPG has a central delegate node (CDNⱼ), selected from each set of IPNⱼₖ (k=1, 2, . . . , Q), for hosting the GJMⱼ and for inter-grid coupling among the IPG (j=1, 2, . . . , P). The remaining unselected IPNⱼₖ are named undelegated nodes (UDN). As a related refinement, the DCCAⱼ further determines, for each IPNⱼₖ, its state of functionality and the DCCAⱼ dynamically selects the CDNⱼ depending upon the so-determined state of functionality so as to make the fault-tolerance of the overall IPG substantially higher than that of any individual IPNⱼₖ. As another related refinement for setting a number of operating policy parameters underlying the operation of the IPGⱼ, the CDNⱼ further includes a standardized grid administrative interface (SGAI) for interfacing with a grid administrating personnel.

In yet another more specific embodiment, the set of IPG are configured to form a peer-to-peer grid in that they are connected at the same logic level and assigning the resource portion IPRPⱼₖᵢ uses an order request-reply qualification protocol between the CDNs of two communicating IPGs. Alternatively, the set of IPG can be configured to form a hierarchical grid in that they are logically connected in a master-slave configuration and assigning the resource portion IPRPⱼₖᵢ uses an order command-execute qualification protocol between a CDN of a master IPG and a CDN of a slave IPG.

These aspects of the present invention and their numerous embodiments are further made apparent, in the remainder of the present description, to those of ordinary skill in the art.

### BRIEF DESCRIPTION OF THE DRAWINGS

In order to more fully describe numerous embodiments of the present invention, reference is made to the accompanying drawings. However, these drawings are not to be considered limitations in the scope of the invention, but are merely illustrative:

FIG. 1 illustrates the formation of an inter grid from the combination of a number of information processing grids coupled to one another through a computer network;

FIG. 2 depicts one example of an inter grid comprised of numerous information processing grids of varying sizes and computing capacities;

FIG. 3 illustrates the relationship between information processing workload, information processing jobs and information processing tasks on an information processing node within an information processing grid;

FIG. 4 illustrates, as part of the embodiment of the present invention, an example internal structure of a single information processing node having a variety of information processing resources for processing information processing jobs;

FIG. 5 illustrates, as a key part of the present invention, the flow of information processing workloads through an inter grid;

FIG. 6 illustrates, as part of the present invention, some sample real-time information processing hardware and software behavioral data measured by DCCA dynamic probes;

FIG. 7 illustrates, as a part of embodiment of the present invention, the relationship between information processing resources, information processing jobs, and DCCA dynamic probes;

FIG. 8 illustrates some samples of a fuzzy logic rules set used by a DCCA intelligent collector in an embodiment of the present invention;

FIG. 9 illustrates, as part of the present invention, the storing of collected real-time information processing hardware and software behavioral data, from DCCA dynamic probes, by DCCA intelligent collectors into an interim job throughput and information processing resource utilization data;

FIG. 10 illustrates, as part of the present invention, a functional example of DCCA intelligent aggregators using a weighting coefficients set to calculate a weighted job throughput and consumption history data table;

FIG. 11 illustrates, in an embodiment of the present invention, the coordination between DCCA and GJM for the purpose of jobs-to-node mapping;

FIG. 12 illustrates, in an embodiment of the present invention, the use of weighted job throughput and consumption history data in a predictive analysis by DCCA to determine a suggested IPJ-dispatchment;

FIG. 13 illustrates, in an embodiment of the present invention, an IPJ-IPR optimization scheme used by GJM for optimizing IPJ-dispatchment; and

FIG. 14 illustrates, in an embodiment of the present invention, a set of selected central delegate nodes within the inter grid for hosting the GJMs and inter-grid coupling.

### DETAILED DESCRIPTION OF PREFERRED EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

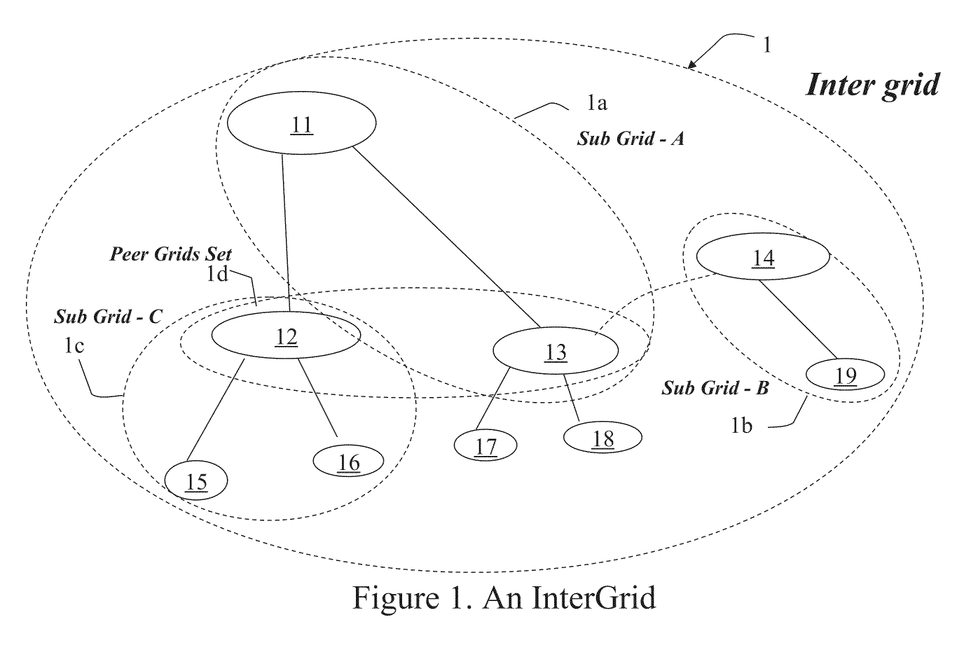

FIG. 1 illustrates the formation of an inter grid (ITGD) 1 from the combination of a number of information processing grids (IPG)₁ 11, IPG₂ 12, IPG₃ 13, IPG₄ 14, IPG₅ 15, IPG₆ 16, IPG₇ 17, IPG₈ 18, IPG₉ 19 coupled to one another through a computer network. The coupling can be further structured arbitrarily to form various sub grids such as Sub Grid-A 1a, Sub Grid-B 1b, Sub Grid-C 1c and a peer grids set 1d. As will be presently illustrated, every IPG itself has a grid of coupled information processing nodes (IPNs) each having its own information processing resources (IPR) capable of processing and executing information processing jobs (IPJs). Thus, the ITGD 1 can simultaneously process and execute a large number of IPJs.

A sub grid can be configured to form a peer-to-peer grid, such as the peer grids set 1d, in that its set of IPGs (IPG₂ 12, IPG₃ 13) are connected at the same logic level and communicated with one another using an order request-reply qualification protocol in between. Notice that the peer IPGs IPG₂ 12, IPG₃ 13 may not have to be directly connected to each another within the ITGD 1. Alternatively, a sub grid can be configured to form a hierarchical grid, such as the Sub Grid-A 1a, wherein its set of IPGs (IPG₁ 11, IPG₃ 13) are logically connected in a master-slave configuration and communicated with one another using an order command-execute qualification protocol in between.

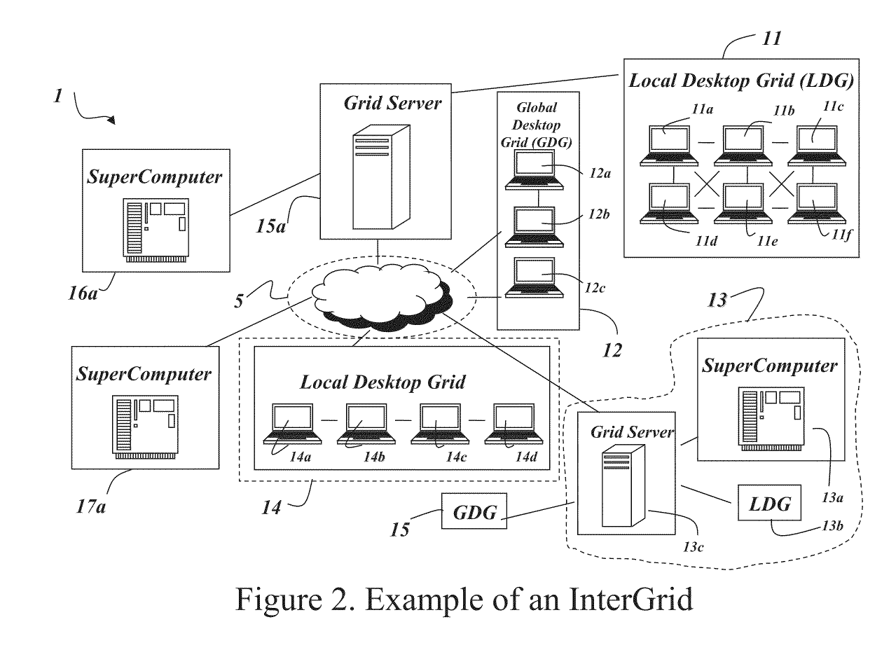

FIG. 2 depicts one example of an ITGD 1 comprised of:
Numerous information processing grids (IPG₁ 11, IPG₂ 12, IPG₃ 13, IPG₄ 14, IPG₅ 15) of varying sizes and computing capacities.
Numerous individual information processing nodes IPN 15a, LBL16a: IPN 16a, LBL17a: IPN 17a.
   The above are connected with one another and also through the Internet 5. Specifically, IPG₁ 11 is a local desktop grid (LDG) with locally coupled IPN 11a, IPN 11b, IPN 11c, IPN 11d, IPN 11e, IPN 11f which are desktop computers. IPG₂ 12 is a global desktop grid (GDG) with globally coupled (over the Internet 5) IPN 12a, IPN 12b, IPN 12c which are desktop computers. IPG₃ 13 is a grid with coupled IPN 13a (a super computer), LDG 13b, IPN 13c (a grid server). IPG₄ 14 is another LDG with locally coupled IPN 14a, IPN 14b, IPN 14c, IPN 14d which are desktop computers. IPG₅ 15 is another GDG with its content not shown here to avoid unnecessary obscuring details. IPN 15a is a single grid server. IPN 16a is a single super computer and likewise IPN 17a is another single super computer.

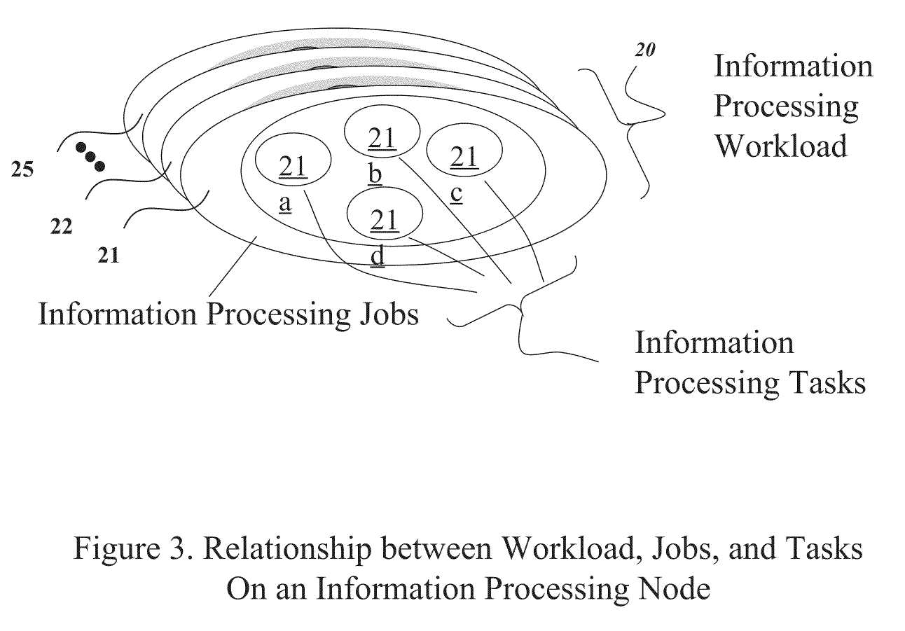

FIG. 3 illustrates the relationship between information processing workload (IPW) 20, information processing jobs IPJ₁ 21, IPJ₂ 22, . . . , IPJₒ 25 and information processing tasks IPTa 21a, IPTb 21b, IPTc 21c, IPTd 21d on an IPN within an IPG. Information processing jobs IPJ₁ 21, IPJ₂ 22, . . . , IPJₒ 25 are submitted for execution in the IPG. When applications associated with each job are scheduled then launched on the IPN they create a number of IPTs, such as IPTa 21a, IPTb 21b, IPTc 21c, IPTd 21d created by IPJ₁ 21. Thus, an IPJ is not considered completed until all of its created IPTs have been completely executed by the IPG. The whole set of IPJs together with their associated IPTs on the IPN then constitute its IPW 20.

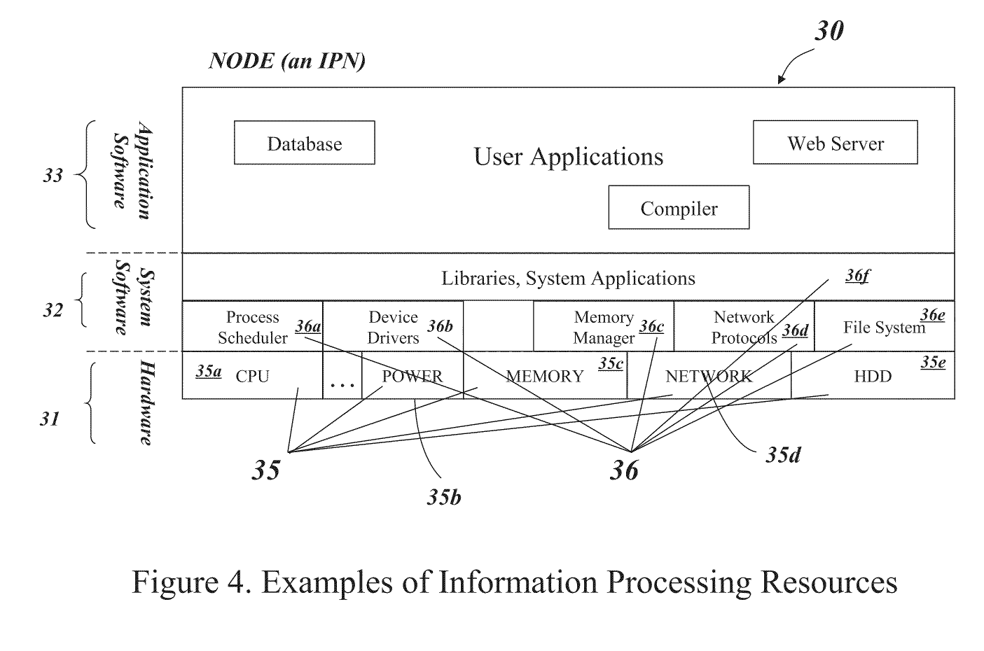

FIG. 4 illustrates, as part of the embodiment of the present invention, an example internal structure of a single information processing node IPN 30 having a variety of IPRs suitable for processing and executing IPJs. To those skilled in the art, the IPN 30 can be seen to have a set of functionally coupled information processing hardware resources (IFP-HW) 35 and information processing software resources (IFP-SW) 36 located at the bottom layers (hardware 31 and system software 32) of the hierarchical structure of IPN 30. On the other hand, the top layer (application software 33) of the hierarchical structure of IPN 30 contains such higher level software entities like:

Compiler

Database, User Applications, Web Server

intimate to the operating system (OS) of IPN 3. Some specific examples of the IFP-HW 35 are:
central processing unit (CPU) 35a, power supply 35b, memory 35c, network interface card 35d, hard disk drive (HDD) 35e
   Some specific examples of the IFP-SW 36 are:
process scheduler 36a, device drivers 36b, memory manager 36c, network protocols 36d, file system 36e, libraries and system applications 36f

As an important characteristics, each of the above IPR has an inherent information processing resource capacity IPRC of which a resource portion IPRP can be assigned for processing an IPJ. The IPRC specifies the maximum information processing capacity of the individual IPR. As a non-limiting example, an IPN may be configured with a CPU with a maximum instruction execution rate of 100 million instructions per second (MIPS). The IPRC of the CPU is then said to be 100 MIPS. As another non-limiting example, the HDD data retrieval rate may be limited to 100 million bytes per second (MB/sec) and may have a storage capacity of 300 billion bytes (GB). Here we would say that the HDD has a retrieval capacity of 100 MB/sec and a storage capacity of 300 GB. Shared IPR components within an IPG have an inherent resource capacity as well. As a non-limiting example, a network switch shared by a set of IPNs may have a maximum packet transmission rate of 100 thousand packets per second (PPS). The switch would then have a capacity of 100K PPS. Likewise, there are inherent capacity limits for any other shared IPRs within the IPG. In some embodiments, individual IPR can be shared among numerous IPJs running on various IPNs. Different IPJs may consume IPRs at different levels and rates based upon their runtime requirements and behavior.

By now it should become clear to those skilled in the art that the execution of each IPJᵢ entails an associated time profile of IPJ throughput and IPR utilization, called JTRUᵢ(t), that is a function of time. Also, each IPR exhibits its own real-time behavior that is correlated to the JTRUᵢ(t). Thus, a higher performance CPU tends to entail a JTRUᵢ(t) of higher job throughput. Whereas, a lower capacity memory tends to entail a JTRUᵢ(t) of higher HDD utilization, etc. As a side remark on including “power supply” as part of the IFP-HW, it is pointed out that in a green computing environment power is a critical resource that should be managed and conserved.

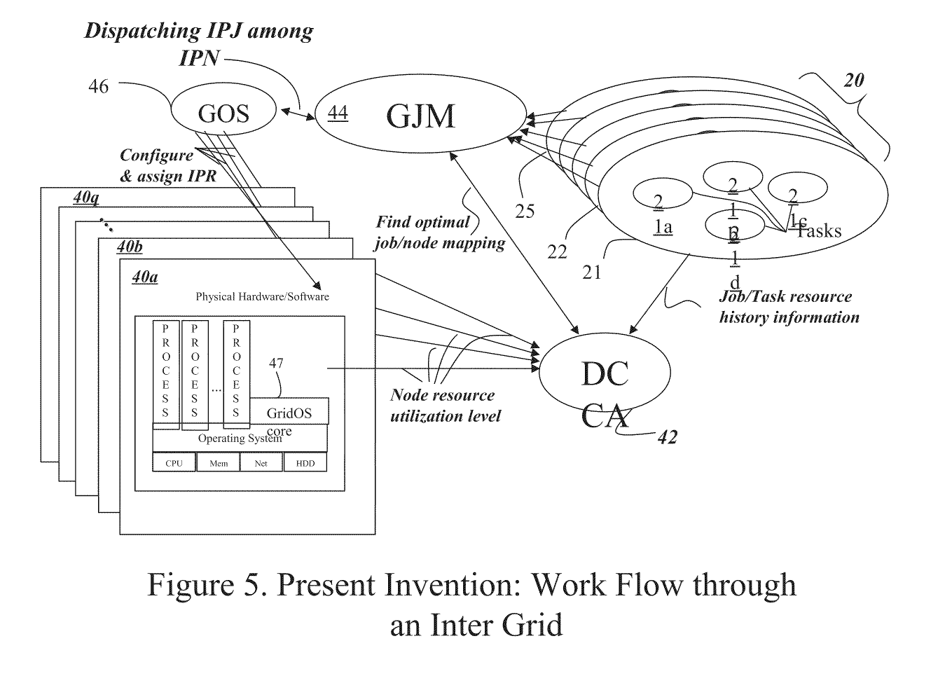

FIG. 5 illustrates, as a key embodiment of the present invention, the flow of IPWs, such as an IPW 20, through an inter grid. Within each IPG, a grid-distributed set of dynamic capacity collection agents (DCCA) 42 is deployed among its IPNs (IPN 40a, IPN 40b, . . . , IPN 40q) and designed to measure and collect, through dynamic probing of the IPN-HW and IPN-SW, each JTRUᵢ(t). Furthermore, a grid-distributed set of job managers (GJM) 44 is deployed, among the IPN 40a, IPN 40b, . . . , IPN 40q, by the DCCA set 42. In addition to working in concert with the DCCA set 42 to process the JTRUᵢ(t) data therefrom, the GJM set 44 also works closely with a grid-distributed set of operating systems (GOS) 46 resident on the IPNs to dispatch and create the required IPJs of IPW on an available and selected set of IPNs. An active component of GOS 46 on each IPN is referred to as the grid operating system core 47 and it carries out DCCA 42 functions for the IPN on which it resides. Recall that each IPN has a variety of IPRs for processing and executing IPJs (examples IPJ₁ 21, IPJ₂ 22, . . . , IPJₒ 25). Also, each of the IPRs has an inherent information processing resource capacity IPRC of which a resource portion IPRP can be assigned for processing an IPJ. Thus, the GJM set 44 is designed to process all the JTRUᵢ(t) together with the IPRCs and to dispatch the IPJs among the IPNs (examples IPN 40a, IPN 40b, . . . , IPN 40q) in a shared way so as to achieve an optimized set of JTRUᵢ(t) of maximized overall job throughput and minimized overall degree of information processing resource utilization for the inter grid. As part of the functionality of the DCCA set 42, it can collect information on node resource utilization level of all the IPNs. In a more specific embodiment the DCCA set 42 can also be designed to function autonomously independent of the dispatchment of IPJs among IPNs by the GJM set 44.

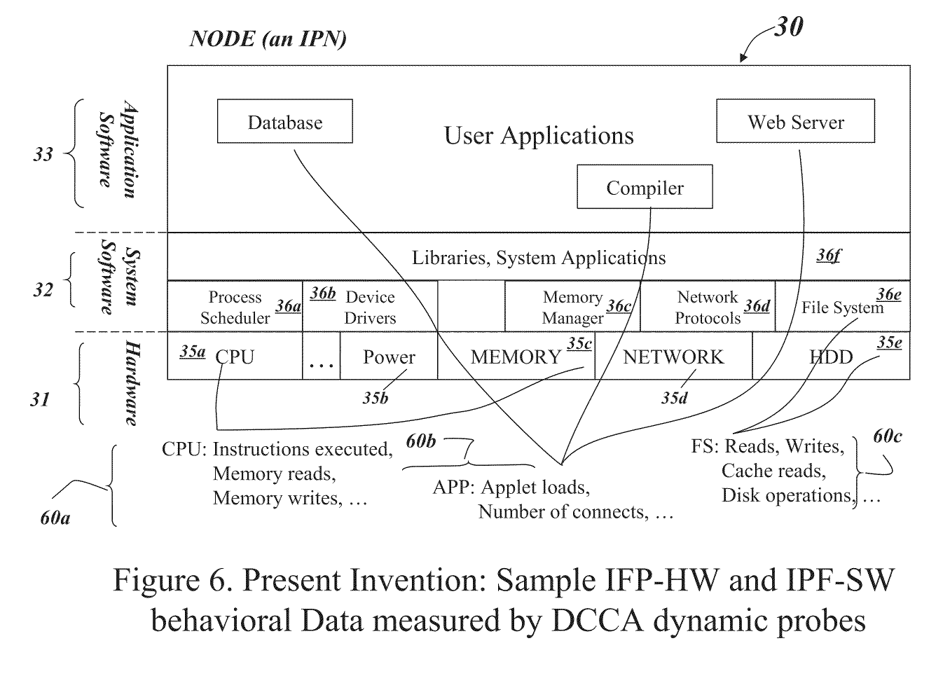

FIG. 6 illustrates, as part of the present invention, some real-time samples of IPR behavioral data:

Sample values of CPU utilization 60a

Sample values of user applications utilization 60b

Sample values of file system utilization 60c

as measured by dynamic probes of the DCCA set 42 from an example IPN 30. To be presently described, these dynamic probes are embedded in the IFP-HW and IFP-SW of each IPN. In particular, the Sample values of CPU utilization 60a are measured from the CPU 35a and include: Instructions executed, Memory reads, Memory writes, . . . , etc. The Sample values of user applications utilization 60b are measured from the User Applications of application software 33 and include: Applet loads, Number of connects, . . . , etc. The Sample values of file system utilization 60c are measured from the file system 36e and include: Reads, Writes, Cache reads, Disk operations, . . . , etc.

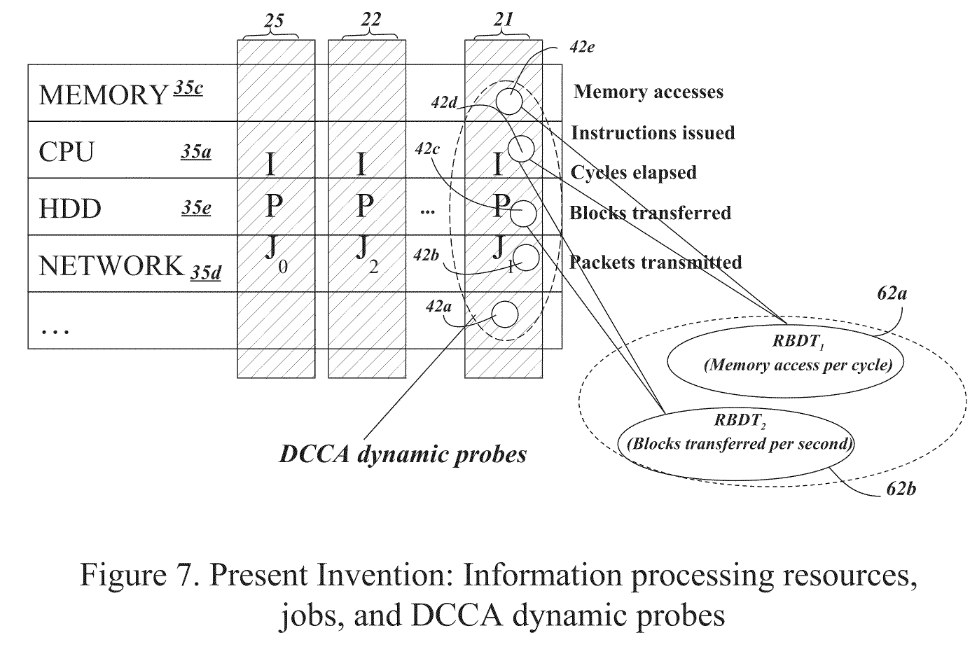

FIG. 7 illustrates, as a part of embodiment of the present invention DCCA set 42, the relationship between:
Information processing resources like CPU 35a, memory 35c, network interface card 35d, HDD 35e
Information processing jobs like IPJ₁ 21, IPJ₂ 22, . . . , IPJₒ 25
DCCA dynamic probes like 42a, 42b, 42c, 42d, 42e.
   Thus, the execution of each of information processing jobs IPJ₁ 21, IPJ₂ 22, . . . , IPJₒ 25 consumes its own portions of the information processing resources CPU 35a, memory 35c, network interface card 35d, HDD 35e, etc. Meanwhile:
The embedded dynamic probe 42d in CPU 35a is measuring “instructions issued” and “cycles elapsed” of JTRUᵢ(t) therefrom.
The embedded dynamic probe 42e in memory 35c is measuring “memory accesses” of JTRUᵢ(t) therefrom.
The embedded dynamic probe 42c in HDD 35e is measuring “blocks transferred” of JTRUᵢ(t) therefrom.
The embedded dynamic probe 42b in network interface card 35d is measuring “packets transmitted” of JTRUᵢ(t) therefrom, etc.
   The corresponding measurement results are illustrated as raw behavioral data (RBDT₁) 62a, RBDT₂ 62b, etc. By now those skilled in the art should recognize that a dynamic probe may be embedded in the IFP-HW and/or IFP-SW of each IPN, in a software stack running on each IPN, or even in some auxiliary components (network switches, power controllers, etc.) that reside in the hardware environment of an IPG. Thus, in certain embodiments the dynamic probes are generic counters or values provided by the IFP-HW that can be collected for further usage. Simply put, the dynamic probes provide an interface to measuring the real-time behavioral data of numerous IPRs. As a specific example, the dynamic probe 42d could be embedded in the core logic of the CPU 35a thus providing a set of user accessible counters that track the CPU 35a activity. As a remark, many modern processors embed internal counters that reveal real-time behavioral information about internal processor operations. Operational characteristics revealed by such embedded processor counters could include instructions executed, memory references made, register loads and stores, processor cycles elapsed, etc. These embedded internal counters are maintained as part of the processor architecture and require no additional hardware overhead to maintain as part of the normal processing operation of user applications. Similarly, hardware probe information could be provided by the network interface card 35d to measure the types and amount of data sent and received at its interface. Likewise, a disk I/O controller could provide similar counter information reflecting the number of blocks of data stored or retrieved from an external persistent I/O device. As a remark, while these hardware probes provide internal accounting of real-time device behavioral information, a layer of software working intimately with these hardware probes is still necessary to collect the behavioral data from the related IFP-HWs. Thus, within the context of embodiment of the present invention, this intimate software layer is considered part of the hardware probe itself.

Although not graphically illustrated here, in some embodiments of the present invention a software DCCA dynamic probe can be created to provide similar behavioral information about logical constructs within a software stack (an IFP-SW). For example, an operating system could provide information related to memory usage. These are software counters that track the number of free memory segments, the number of task switches, and current number of active tasks on the IPN. As such, they may provide insight into the current utilization level of operating system controlled resources. Similarly, a database could provide software counters related to the number of transactions issued, the amount of data contained within the current store, or the number of times a particular data table has been accessed. Hence, these software DCCA dynamic probes may provide access to specific usage data that correlate directly to each IPR and also provide specific utilization statistics for that IPR. Thus, in general, the DCCA dynamic probes can be embodied physically or logically and can reside at any point within the software or hardware structure of an IPG. As additional enhancements, the present invention can be further embodied to support the use of business resources with their related probes such as usage costs for various IPRs, current electrical power rates on the local market of an IPN, network bandwidth charges from the Internet data center, etc. These can all be thought of as commodities offered within the scope of the IPG.

A dynamic probe can be created through a set of common application programming interfaces (APIs), which allow access to underlying hardware probes or software probes maintained by system software or application software components on an IPN. A DCCA dynamic probe can return a single counter value associated with a specific action of an IPR or combine multiple measured resource values into an aggregated abstract value. As an example, a DCCA dynamic probe might utilize a monotonically increasing counter to accumulate the number of instructions executed since a CPU began its execution. This monotonically increasing counter value can be obtained at any time from the common API of a CPU resource probe. Alternatively, the DCCA dynamic probe might also acquire the number of clock ticks of the processor since it began its execution. This clock tick value could be obtained in the same manner as that for the acquisition of number of instructions. The DCCA dynamic probe could then combine these measured values to derive a rate value of instructions executed per CPU cycle over a rate collection interval (e.g., instructions per cycle=(instructions_end−instructions_start)/(cycles_end−cycles_start). Furthermore, the DCCA dynamic probe may create a logical abstraction or aggregation from its measured raw values. Sometimes, these logical aggregations are useful for a variety of collectors hence the information can be reused for multiple higher level functions.

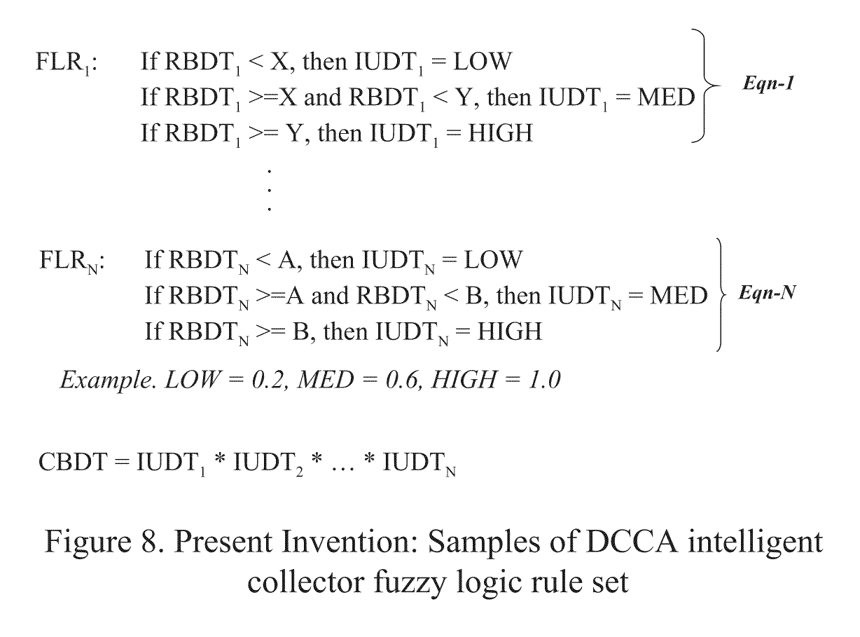

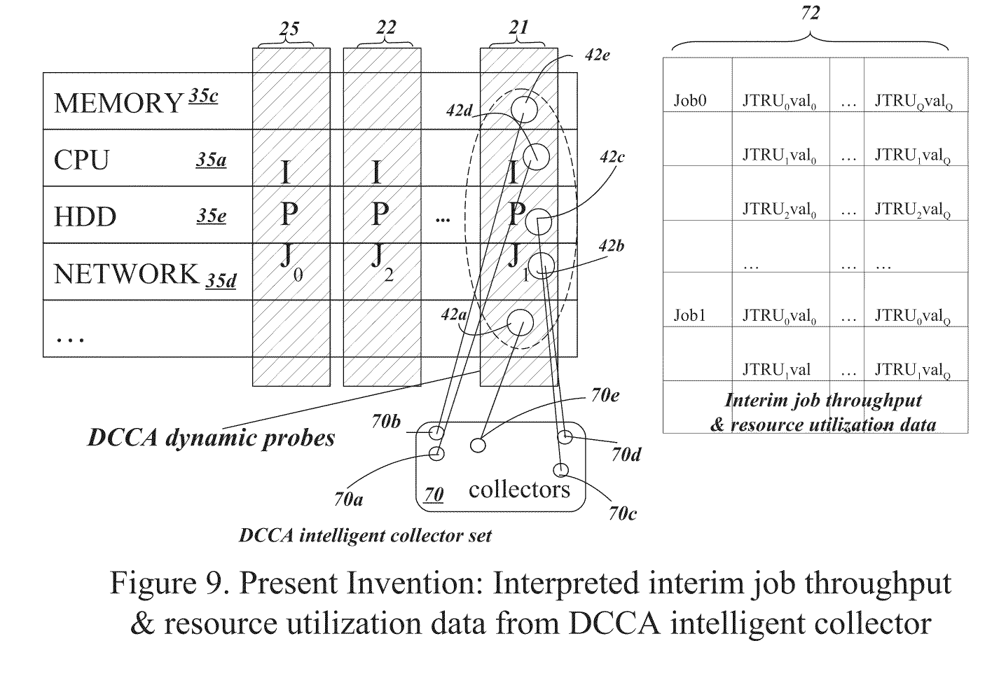

FIG. 8 and FIG. 9 illustrate, again under the present invention, a grid-distributed set of DCCA intelligent collectors 70 (with component DCCA intelligent collectors 70a, 70b, 70c, 70d, 70e) coupled to the DCCA dynamic probes (42a, 42b, 42c, 42d, 42e) for collecting then intelligently interpreting the so collected raw behavioral data (RBDT₁ 62a, RBDT₂ 62b, etc.) into an interim job throughput and information processing resource utilization (JTRU) data 72 for each IPJ and each IPR throughout the IPG.

In a preferred embodiment for intelligently interpreting the real-time behavioral data, FIG. 8 illustrates some samples of a fuzzy logic rules (FLR) set used by the DCCA intelligent collector set 70 to map the raw behavioral data into the interim JTRU data 72. The samples include FLR Boolean equations Eqn-1, . . . , Eqn-N and an arithmetic equation for collected real-time behavior data (CBDT). Where:
RBDT₁, . . . , RBDT_{N} are specific RBDT values gathered by the DCCA dynamic probes.
The comparand values (X, Y, A, B) are chosen based on the characteristics of the specific IPR being monitored. For one example, a processor has a specific peak instruction issue rate and the comparands can be chosen based upon this peak rate, etc.
Eqn-1, . . . , Eqn-N respectively maps RBDT₁, . . . , RBDT_{N} into a set of interim resource utilization data IUDT₁, . . . , IUDT_{N} each equal to LOW, MEDIUM or HIGH. The range of (LOW, MEDIUM, HIGH) is between 0 and 1, thus corresponding to a normalized IPR utilization value. Equivalently, the job throughput is expressed in the form of %-completion per unit time and the information processing resource utilization is expressed in the form of %-resource utilization.
If a DCCA intelligent collector uses multiple DCCA dynamic probes then there is at least one FLR covering each probe.
In the CBDT calculation, the results of all the FLRs are then aggregated (*=multiplication) to provide a single CBDT result for the DCCA intelligent collector.
   To those skilled in the art it should become clear by now that numerous other types of resource rules, other than the above illustrated fuzzy logic rules, are available in the art and can be adopted for mapping the raw behavioral data into the interim JTRU data 72. For example, a simple binary rule could be implemented for each IPR that simply indicates whether any activity has occurred since the late time that IPR was probed. If so, a value of 1 would be returned. Otherwise, the rule would return a value of 0. Another example may be a simple rule set that would monitor directional change for an IPR. If a DCCA dynamic probe returned a value larger than the previously returned value, the resource rule could return a larger value (e.g., 0.75). If the DCCA dynamic probe returned a smaller value than it had previously returned, the resource rule would return a smaller value (e.g., 0.25). One more example would be that of a measured trend or derivative rules set. This approach might measure the rate of change of a resource over time. For example, if difference between the values returned in the last two queries to a DCCA dynamic probe is greater than the difference in the previous two queries, the trend would be upward, meaning that the rule would return a value>0.5. Otherwise, the trend would be downward or static and a value<=0.5 would be returned.

In FIG. 9, the set of IUDT₁, . . . , IUDT_{N} are stored by the grid-distributed set of DCCA intelligent collectors 70 into tabulated interim job throughput and information processing resource utilization data 72. As shown, the tabulation can be organized into a time sequence of JTRU(t) values and further indexed across IPJs and IPRs, as a historical data record from the DCCA intelligent collector set 70. As a refinement, this historical data record may be further processed by the DCCA intelligent collector set 70 to maintain a separate damped JTRU(t) record over any data collection period. An example of the damped JTRU(t) record would be:
Damped JTRU(t)=AVERAGE (JTRU(t−j)), where j=0, 1, 2, 3, . . . Q and Q>=1. Alternative schemes including, but not limited to, weighted average, maximum, minimum, etc., could be used to calculate the Damped JTRU(t) over the collection period as well.

While the present invention disclosure so far focuses on the probing and collection of various IPRs by DCCA probes and collectors, by now it should become clear to those skilled in the art that the scope of the present invention can include applications to other types of resources as well. By way of example, such other types of resources could include but not necessarily limited to monetary cost, calendar date, job execution history, customer-reserved computing capacity, etc.

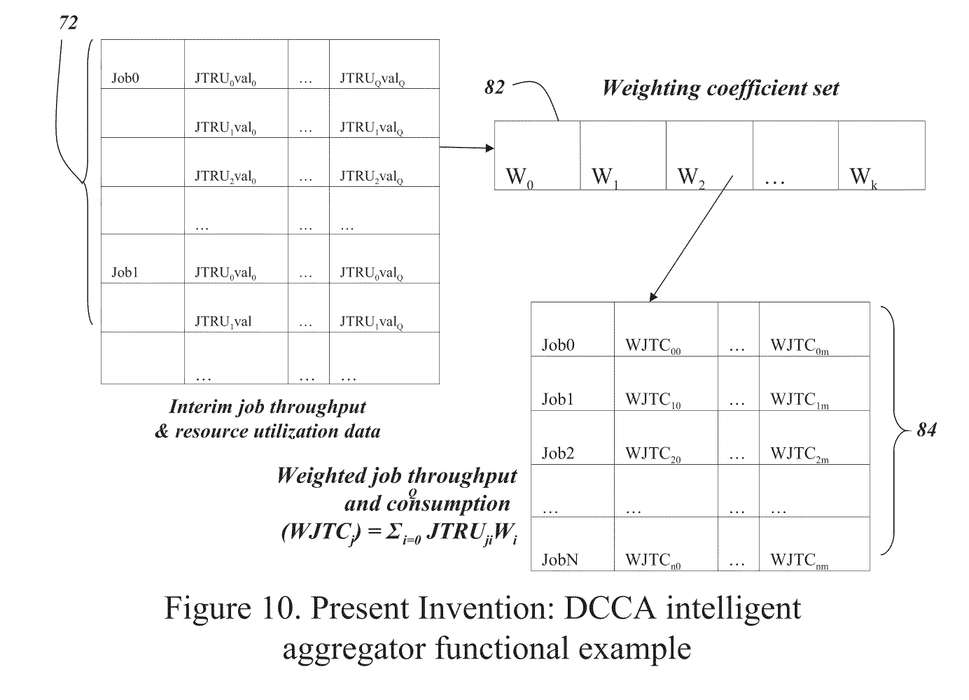

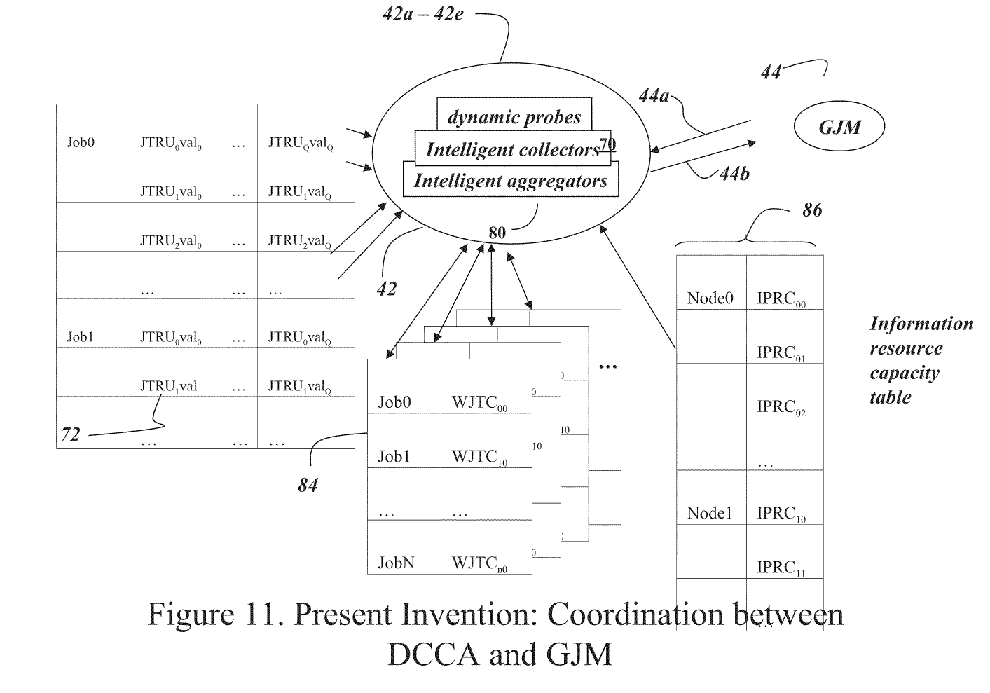

FIG. 10 and FIG. 11 illustrate, as part of the present invention, a functional example of grid-distributed set of DCCA intelligent aggregators 80 using a weighting coefficients set 82 to calculate and tabulate a weighted job throughput and consumption history (WJTC) table 84. As depicted in FIG. 11, the distributed set of DCCA intelligent aggregators 80 is an element of the DCCA set 42 and coupled to the DCCA intelligent collector set 70. In turn, the DCCA set 42 is coupled to a grid-distributed set of job managers (GJM) 44. In operation, the DCCA aggregator set 80 applies an individualized weighting coefficient Wᵢ to each of the collector values JTRUᵢ(t) to determine a weighted aggregate for each job. The weighting coefficients are flexible in that they can be configured on either a per-installation or a per-job basis. Thus, the weighting coefficients will influence the IPJ-dispatching behavior of the inter grid. For example, if power consumption is considered a key IPR to be emphasized, the weighting coefficient for the ‘power consumption’ collector will be increased. On the other hand, if network throughput is a key IPR, then the weighting coefficient for the ‘network’ collector will be increased. As a practice, the DCCA aggregator set 80 may use a resource weighting table (RWTₖ k=1, 2, 3, . . . , O where O>=1), with table entries directly correspond to each IPRₖ, to signify the relative importance of each IPRₖ in the IPJ-dispatching strategy of the GJM 44 in the inter grid. Additionally, various transformations can be performed on the RWT and JTRU tables to predict an optimal dispatching of IPJs onto IPNs. In one embodiment, the DCCA aggregator set 80 can be configured to utilize a neural network with node values consisting of Weighted Job throughput and Consumption (WJTCⱼ) that can be obtained through the following vectorized calculation:

WJTCⱼ=SUM(JTRUⱼᵢ*Wᵢ,i=0,1,2, . . . ,q) (1)

In addition to the above, it should be noted that numerous other transformations can be performed on the RWT and JTRU tables to provide other useful information as well. For example, a consumer of DCCA data may be interested in determining if any single IPR might be overcommitted given a contemplated set of IPJs. This may be determined by aggregating the values across the contemplated job set for each of the individual resources.

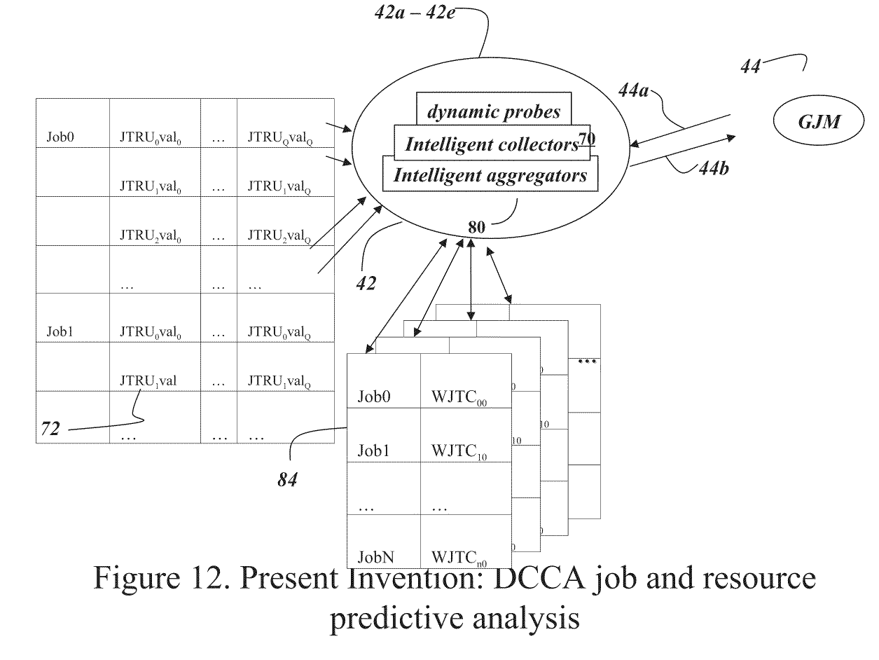

In any case, as is illustrated in FIG. 12 with a simplified form, responding to an IPJ-dispatching request 44a from the GJM 44, the DCCA set 42 can now utilize the WJTC table 84 in combination with a pre-determined information processing resource capacity (IPRC) table 86 (now tabulated against IPNs and IPRs, for more detailed descriptions of IPRC please reference FIG. 4 and FIG. 5) and determine a suggested IPJ-dispatchment 44b through a predictive analysis. Here, the DCCA aggregator set 80 can compare the WJTC table 84 for the available IPJs against the current IPR utilization and capacity for the available IPNs and perform a fitting algorithm based upon the IPJ-dispatching request 44a from the GJM 44. Based upon this predictive analysis, the GJM 44 may place new jobs that are presented to the inter grid. By the same token, the GJM 44 can also determine which set of nodes may best accommodate an incoming job stream. For those cases where a job has not yet accumulated a current historical behavioral record, the DCCA 42 can either assume an initial value that is an average behavior for the job type or request general behavioral parameters from the GJM 44. These general behavioral parameters can then be used to determine a first approximation of the correct dispatchment of the job.

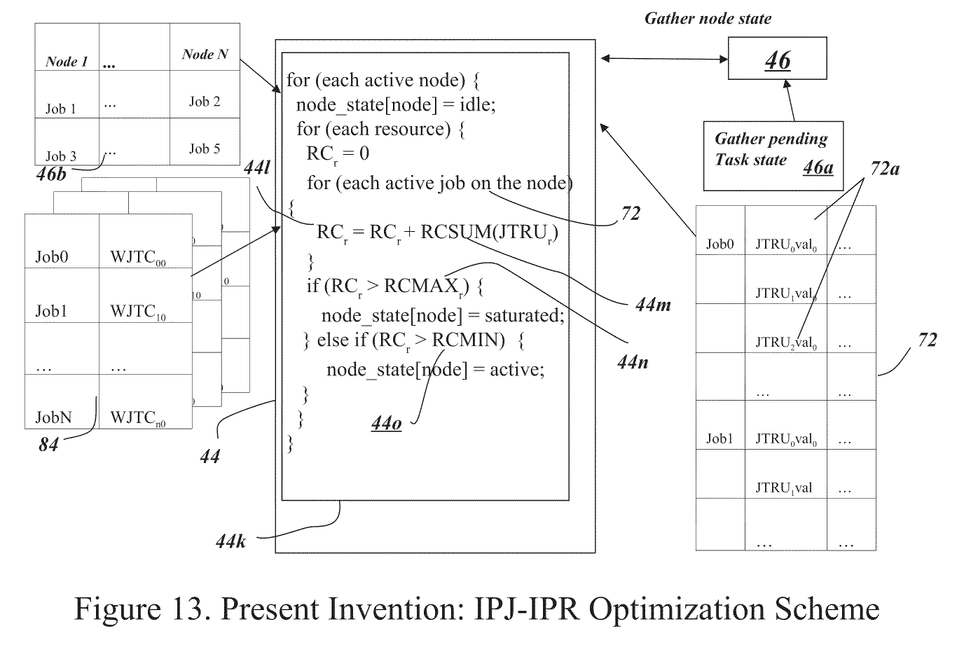

FIG. 13 illustrates, in an embodiment of the present invention, an IPJ-IPR optimization scheme used by GJM 44 for optimizing IPJ-dispatchment among the inter grid. In operation, the GJM 44 maintains a IPJ-IPN mapping table 46b and is coupled to the GOS set 46 which is regularly gathering pending task state 46a. The GJM 44 has an IPJ-IPR optimization algorithm 44k that, using the normalized set of JTRUᵢ(t) now in the form of the WJTC table 84, assigns and adjusts all resource portions IPRPs for all IPJs for an anticipated optimized set of JTRUᵢ(t). In a preferred embodiment similar to the DCCA aggregator set 80, the IPJ-IPR optimization algorithm 44k has and employs a neural network based upon the WJTC table 84. The IPJ-IPR optimization algorithm 44k also includes a JTRU-iterating scheme that monitors the time evolution of the WJTC table 84 and, upon detecting a significant change of the WJTC table 84, reassigns and readjusts all IPRPs for all IPJs. As a non-limiting example, consider three IPJs in a work queue for which the GJM 44 is attempting to determine a dispatchment. A normalized JTRU(t) value has been computed for a shared IPR, for example, a network interface card. Here, IPJ-1 has been measured to consume 40% of this resource, IPJ-2 has a consumption level of 65% and IPJ-3 has a consumption level of 50%. If IPJ-2 were co-scheduled with either one of the other IPJs, the shared IPR would be overcommitted and the performance of both scheduled jobs may suffer. However, if IPJ-2 is scheduled on a separate IPN, all three jobs may execute at full speed along this IPR-dimension (performance of network interface card) without interfering with the progress of the other jobs. To those skilled in the art, this concept can be extended to multiple IPR-dimensions using all of the content of the WJTC table 84. Furthermore, as weighting coefficients are applied to the calculations across each IPR-dimension, priority can be given to the use of one IPR over another through proper adjustment of the corresponding weighting coefficients and this effectively changes the selection criteria of the underlying IPJ-IPR optimization algorithm 44k.

As further illustrated with a fragment of programming language in C-code, the IPR-IPJ optimization algorithm 44k may utilize the IPJ-IPN mapping table 46b and the interim JTRU data 72 to determine the resource capacity state of IPNs within the inter-grid 1. By iterating over the jobs residing on the individual IPNs per IPJ-IPN mapping table 46b and the resources consumed by these jobs per interim JTRU data 72, the IPJ-IPR optimization algorithm 44k may determine the readiness of any IPN to accept new IPW. In this embodiment, the algorithm 44k may calculate the sum of JTRUᵣ 72 for each measured IPR across all IPJs assigned to the IPN by applying a summary function 44m (e.g., average or weighted average) over the values collected for each JTRUr 72. By interrogating the aggregated resource utilization 44l across the IPJs for an IPN, a determination can be made as to whether such utilization exceeds a minimum threshold value 44o or a maximum threshold value 44n. If an individual IPR is found to be consumed beyond the maximum threshold 44n, the corresponding IPN may be determined to be saturated and not a good candidate for additional IPJs. If, on the other hand, no IPR is found to exceed the minimum threshold 44o, the corresponding IPN may be considered to be idle and as such may be considered a good candidate for additional IPJs.

To those skilled in the art it should become clear by now that numerous such equivalent (to the optimization algorithm 44k) algorithms exist that could utilize the data content of the dynamic capacity collection agents (DCCA) 42 to impact the IPJ-dispatching strategy of the GJM 44 in the inter grid. For example, the IPR-IPJ optimization algorithm 44k may utilize the WJTC table 84 to provide a more efficient determination of the aggregated resource utilization 44l for each IPN. Since these utilization values may be normalized and weighted by the DCCA 42, the aggregated resource utilization 44l may more accurately reflect the configured resource priorities as reflected by the weighting coefficients set 82. Another example may use an average of WJTC information over several time intervals to estimate the resource utilization on each IPN. A further example of an alternate IPR-IPJ optimization algorithm may use the maximum value recorded for each job in the WJTC table and determine which IPN provides the most favorable matching with the IPJ under consideration by the DCCA.

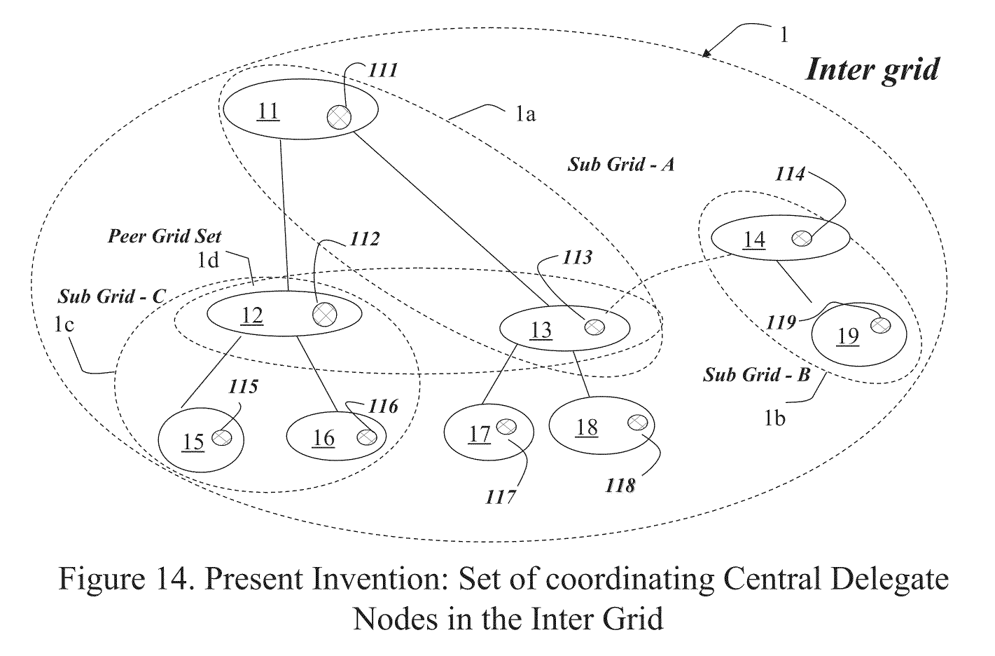

FIG. 14 illustrates, in another embodiment of the present invention, a set of selectively assigned central delegate nodes CDN 111, CDN 112, . . . , CDN 119 within the ITGD 1 for hosting the above-described GJM 44 and for simplification of control and management functions among the IPG₁ 11, IPG₂ 12, . . . , IPG₉ 19. Thus:
CDN 111 is the selected CDN of IPG₁ 11, CDN 112 is the selected CDN of IPG₂ 12, . . . , CDN 119 is the selected CDN of IPG₉ 19.
   Although not specifically illustrated in FIG. 14, the remaining unselected IPNs throughout the ITGD 1 are named undelegated nodes (UDN). As an example from IPG4 14 in FIG. 2, suppose the IPN 14c has been selected as its CDN, then the IPNs 14a, 14b, 14d are all UDNs. Therefore, for the case of peer-to-peer grid, assigning the resource portion IPRP uses an order request-reply qualification protocol between the CDNs of two communicating IPGs. On the other hand, for the case of hierarchical grid, assigning the resource portion IPRP uses an order command-execute qualification protocol between a CDN of a master IPG and a CDN of a slave IPG. Grids can be arbitrarily and dynamically combined through their cooperating CDNs within the ITGD 1. Grid management functions such as, but not limited to, IPJ management, IPJ dispatching and DCCA aggregation are performed through a set of cooperating CDNs within the ITGD 1. Certain IPNs within an IPG may have special information processing resources and/or capabilities that allow them to uniquely perform certain tasks for an IPJ. Some non-limiting examples include a node with special hardware processing capabilities, a node with special access privilege to a particular data set or application software program, or a node that is addressable only through a direct internet protocol (IP) address. Therefore, the GJM 44 should dispatch IPJs to their matching IPNs.

As a related refinement, the DCCA 42 can be functionally equipped so that it can determine, for each IPN, its state of functionality and it can dynamically select a proper CDN depending upon the so-determined state of functionality. In this way, the fault-tolerance of an overall IPG can be made substantially higher than that of any individual IPN within the IPG. As another related refinement for setting a number of operating policy parameters underlying the operation of each IPG, the CDNⱼ can be further equipped to include a standardized grid administrative interface (SGAI) for interfacing with a grid administrating personnel.

An inter grid has been invented for simultaneously executing a number of information processing jobs with overall high job throughput and efficient utilization of information processing resources. Throughout the description and drawings, numerous exemplary embodiments were given with reference to specific configurations. It will be appreciated by those of ordinary skill in the art that the present invention can be embodied in numerous other specific forms and those of ordinary skill in the art would be able to practice such other embodiments without undue experimentation. The scope of the present invention, for the purpose of the present patent document, is hence not limited merely to the specific exemplary embodiments of the foregoing description, but rather is indicated by the following claims. Any and all modifications that come within the meaning and range of equivalents within the claims are intended to be considered as being embraced within the spirit and scope of the present invention.

What is claimed is:

1. An inter grid (ITGD) for simultaneously executing a number of information processing jobs IPJᵢ (i=1, 2, . . . , O and O>=1) with efficient utilization of information processing resources (IPR), where the execution of each IPJᵢ entails an associated time profile of job throughput and information processing resource utilization JTRUᵢ(t), the ITGD comprises:
P information processing grids (IPG) IPGⱼ (j=1, 2, . . . , P and P>=1) coupled to one another through a computer network wherein each IPGⱼ comprises:
a grid of coupled information processing nodes IPNⱼₖ (k=1, 2, . . . , Q and Q>=1) each having its own IPRⱼₖ characterized by an inherent information processing resource capacity (IPRCⱼₖ) of which a resource portion IPRPⱼₖᵢ can be assigned for processing an information processing job IPJᵢ;
a dynamic capacity collection agent (DCCAⱼ), being deployed among the IPNⱼₖ (k=1, 2, . . . , Q), for measuring and collecting each JTRUᵢ(t); and
a grid job manager (GJMⱼ) being deployed by the DCCAⱼ among the IPNⱼₖ (k=1, 2, . . . , Q) and coupled to the DCCAⱼ, for processing the JTRUᵢ(t) together with the IPRCⱼₖ and dispatching the IPJᵢ (i=1, 2, . . . , O) among the IPNⱼₖ (k=1, 2, . . . , Q) in a way so as to achieve an optimized set of JTRUᵢ(t) of maximized overall job throughput and minimized overall degree of information processing resource utilization for the ITGD.

2. The ITGD of claim 1 wherein dispatching the IPJᵢ comprises dispatching at least one information processing job among a plurality of information processing nodes thus achieving job processing with shared information processing resources across information processing nodes.

3. The ITGD of claim 1 wherein each DCCAⱼ functions autonomously independent of the dispatchment of the IPJᵢ among the information processing nodes.

4. The ITGD claim 1 wherein said IPRⱼₖ of each IPNⱼₖ comprises a set of functionally coupled information processing hardware (IFP-HW) and information processing software (IFP-SW) exhibiting real-time behavioral data correlated to the JTRUᵢ(t) and wherein said DCCAⱼ comprises:
a dynamic probing means embedded in the IFP-HW and IFP-SW of each IPNⱼₖ for continually measuring their real-time behavioral data;
an intelligent collecting means coupled to the dynamic probing means for collecting then intelligently interpreting the so collected real-time behavioral data into an interim job throughput and information processing resource utilization data for each IPJᵢ and each IPRⱼₖ throughout the IPG; and
an intelligent aggregating means coupled to the intelligent collecting means for intelligently aggregating the interim job throughput and information processing resource utilization data into the set of JTRUᵢ(t) (i=1, 2, . . . , O).

5. The ITGD of claim 4 wherein said intelligent aggregating means further normalizes the set of JTRUᵢ(t) so that the job throughput is expressed in the form of %-completion per unit time and the information processing resource utilization is expressed in the form of %-resource utilization.

6. The ITGD of claim 4 wherein, for intelligently interpreting the real-time behavioral data, the intelligent collecting means comprises and employs a set of fuzzy logic rules mapping the real-time behavioral data into the interim job throughput and information processing resource utilization data.

7. The ITGD of claim 4 wherein, for aggregating the interim job throughput and information processing resource utilization data across the numerous IFP-HW and IFP-SW, the intelligent aggregating means comprises and employs a set of weighting coefficients, each reflecting the relative importance of its corresponding IFP-HW or IFP-SW, multiplied to their corresponding interim information processing resource utilization data during the aggregation process.

8. The ITGD of claim 5 wherein said GJMⱼ comprises:
a) an information processing job-resource (IPJ-IPR) optimizing means for, using the normalized set of JTRUᵢ(t), assigning and adjusting all resource portions IPRPⱼₖᵢ for all information processing jobs IPJᵢ for an anticipated optimized set of JTRUᵢ(t); and
b) a JTRU-iterating means for, upon detecting a significant change of the normalized set of JTRUᵢ(t), returning to step a).

9. The ITGD of claim 8 wherein, for adjusting all resource portions IPRPⱼₖᵢ for all information processing jobs IPJᵢ, said IPJ-IPR optimizing means comprises and employs a neural network based upon the normalized set of JTRUᵢ(t).

10. The ITGD of claim 1 wherein each IPG comprises a central delegate node (CDNⱼ), selected from each set of IPNⱼₖ (k=1, 2, . . . , Q), for hosting the GJMⱼ and for inter-grid coupling among the IPG (j=1, 2, . . . , P) with the remaining unselected IPNⱼₖ named undelegated nodes (UDN).

11. The ITGD of claim 10 wherein the DCCAⱼ further determines, for each IPNⱼₖ, its state of functionality and said DCCAⱼ dynamically selects the CDNⱼ depending upon said state of functionality so as to make the fault-tolerance of the overall IPGⱼ substantially higher than that of any individual IPNⱼₖ.

12. The ITGD of claim 10 wherein said CDNⱼ further comprises:
a standardized grid administrative interface (SGAI) for interfacing with a grid administrating personnel
whereby setting a number of operating policy parameters underlying the operation of the IPGⱼ.

13. The ITGD of claim 10 wherein the set of IPGⱼ forms a peer-to-peer grid in that the set of IPG are connected at the same logic level and assigning the resource portion IPRPⱼₖᵢ comprises an order request-reply qualification protocol between the CDNs of two communicating IPGs.

14. The ITGD of claim 10 wherein the set of IPG forms a hierarchical grid in that the set of IPGⱼ are logically connected in a master-slave configuration and assigning the resource portion IPRPⱼₖᵢ comprises an order command-execute qualification protocol between a CDN of a master IPG and a CDN of a slave IPG.

15. A method for maximizing overall job throughput while minimizing degree of information processing resource utilization throughout the simultaneous execution of a number of information processing jobs IPJᵢ (i=1, 2, . . . , O and O>=1) by an inter grid (ITGD) of information processing grids IPGⱼ (j=1, 2, . . . , P and P>=1) coupled to one another through a computer network, wherein each IPGⱼ comprises:
a grid of coupled information processing nodes IPNⱼₖ (k=1, 2, . . . , Q and Q>=1) each having its own IPRⱼₖ characterized by an inherent information processing resource capacity (IPRCⱼₖ) of which a resource portion IPRPⱼₖ, can be assigned for processing an information processing job IPJᵢ, where the execution of each IPJᵢ entails an associated time profile of job throughput and information processing resource utilization JTRUᵢ(t), the method comprises:
measuring and collecting each JTRUᵢ(t); and
processing the IPRCⱼₖ together with the collected JTRUᵢ(t) and dispatching the information processing jobs IPJᵢ amongst the information processing nodes IPNⱼₖ by assigning each IPRPⱼₖᵢ in a way so as to achieve a maximized overall job throughput and a minimized overall information processing resource utilization for the ITGD.

16. The method of claim 15 wherein measuring and collecting each JTRUᵢ(t) comprise deploying a dynamic capacity collection agent (DCCAⱼ) among the IPNⱼₖ (k=1, 2, . . . , Q) to measure and collect each JTRUᵢ(t).

17. The method of claim 15 wherein processing and dispatching comprise deploying a grid job manager (GJMⱼ) among the IPNⱼₖ (k=1, 2, . . . , Q) to process and dispatch.

18. The method of claim 15 wherein measuring and collecting each JTRUᵢ(t) are autonomously carried out independent of the dispatchment of the IPJᵢ (i=1, 2, . . . , O) among the IPNⱼₖ (k=1, 2, . . . , Q).

19. The method of claim 15 wherein measuring and collecting each JTRUᵢ(t) further comprise normalizing the set of JTRUᵢ(t) so that the job throughput is expressed in the form of %-completion per unit time and the information processing resource utilization is expressed in the form of %-resource utilization.

20. The method of claim 19 wherein processing and dispatching comprises:
a) using the normalized set of JTRUᵢ(t), assigning and adjusting all resource portions IPRPⱼₖᵢ for all information processing jobs IPJᵢ for an anticipated maximized overall job throughput and a minimized overall information processing resource utilization for the ITGD; and
b) upon detecting a significant change of the normalized JTRUᵢ(t) set, returning to step a).

21. The method of claim 20 wherein assigning and adjusting comprise employing a neural network based upon the normalized set of JTRUᵢ(t).

22. The method of claim 15 wherein, for intelligently interpreting the JTRUᵢ(t), measuring and collecting each JTRUᵢ(t) comprise employing a set of fuzzy logic rules mapping each collected JTRUᵢ(t) into an interim job throughput and information processing resource utilization data.
